(19) United States
(12) Patent Application Publication
(10) Pub. No.: US 2025/0325032 A1
(43) Pub. Date: Oct. 23, 2025

(54) An Aerosol Generating Device

(71) Applicant: JT International SA, Geneva (CH)

(72) Inventors: Layth Sliman Bouchuiguir, Bellevue (CH); Pier Paolo Monticone, Le Grand Saconnex (CH)

(73) Assignee: JT International SA, Geneva (CH)

(21) Appl. No.: 18/852,124

(22) PCT Filed: Mar. 27, 2023
(86) PCT No.: PCT/EP2023/057830

§ 371 Date: Sep. 27, 2024

(30) Foreign Application Priority Data
Mar. 30, 2022 (EP) 22165527.7

(51) Int. Cl. A24F 40/46; A24F 40/20; H05B 6/10

(52) U.S. Cl. CPC A24F 40/46; A24F 40/20; H05B 6/108

(57) ABSTRACT

An aerosol generating device includes a heating assembly. The heating assembly includes a heating compartment arranged to receive an aerosol generating article. The aerosol generating device further includes a lid configured to be moveable by a user to open and close the heating compartment. The aerosol generating device further includes a removeable cover locatable on a body of the aerosol generating device. The aerosol generating device further includes a fastening arrangement. The fastening arrangement is configured to mechanically fasten the removeable cover to the body when the lid is moved by a user to open the heating compartment and to mechanically unfasten the removeable cover from the body when the lid is moved by a user to close the heating compartment.

### TECHNICAL FIELD

The present disclosure relates generally to an aerosol generating device, and more particularly to an aerosol generating device for heating an aerosol generating substrate to generate an aerosol for inhalation by a user.

### TECHNICAL BACKGROUND

The popularity and use of reduced-risk or modified-risk devices (also known as vaporisers) has grown rapidly in recent years as an alternative to the use of traditional tobacco products. Various devices and systems are available that heat or warm, rather than burn, an aerosol generating substrate to generate an aerosol for inhalation by a user.

A commonly available reduced-risk or modified-risk device is an aerosol generating device, or so-called heat-not-burn device. Devices of this type generate an aerosol or vapour by heating an aerosol generating substrate, for instance comprised in an aerosol generating article such as a heated tobacco stick, to a temperature typically in the range 150° C. to 300° C., in a heating compartment. Heating the aerosol generating substrate to a temperature within this range, without burning or combusting the aerosol generating substrate, generates a vapour which typically cools and condenses to form an aerosol for inhalation by a user of the device.

Typically, a cover is locatable on a body of an aerosol generating device providing a heat insulation barrier so that the device can be comfortably held by a user during a vaping session. In some instances, to allow access to the body of the device the cover is removeable. As a safety precaution, heating is automatically disabled should the cover be removed. Inadvertently removing the cover therefore disrupts a vaping session, which is inconvenient for a user. Furthermore, the exposed body of the device can be hot and is therefore a safety risk for the user.

There is, therefore, a need to provide an aerosol generating device which mitigates these drawbacks.

### SUMMARY OF THE DISCLOSURE

According to a first aspect of the present disclosure, there is provided an aerosol generating device comprising:
a heating assembly, wherein the heating assembly comprises a heating compartment arranged to receive an aerosol generating article;
a lid configured to be moveable by a user to open and close the heating compartment;
a removeable cover locatable on a body of the aerosol generating device; and
a fastening arrangement configured to mechanically fasten the removeable cover to the body when the lid is moved by a user to open the heating compartment and to mechanically unfasten the removeable cover from the body when the lid is moved by a user to close the heating compartment.

The removeable cover may substantially conceal a front face and/or rear face the body of the aerosol generating device when the cover is located on the body. The removeable cover may define at least partly an external surface of the aerosol generating device. The removeable cover may have an inner surface positioned adjacent to the body, and possibly in contact with the body, and an outer surface which may define at least partly the external surface of the aerosol generating device.

An aerosol generating article can only be received in the heating compartment of an aerosol generating device when the heating compartment is open. The aerosol generating device can only therefore be used for a vaping session when the heating compartment is open. In this configuration, the removeable cover is mechanically fastened to the body by the fastening arrangement. The fastening arrangement can only be unfastened to permit removeable of the removeable cover by a user moving the lid to close the heating compartment after the aerosol generating article has been removed, for instance at the end of a vaping session. This arrangement therefore prevents inadvertent removal of the removeable cover during a vaping session and automatic disabling of heating, and thus the associated inconvenience caused by disrupting the vaping session. This arrangement also mitigates safety risks associated with exposing a potentially hot body.

The lid may be slidably moveable, e.g., linearly slidable, by a user to open and close the heating compartment.

Possibly, the fastening arrangement comprises:
a fastener; and
a receiver, wherein, in use, moving the lid to open the heating compartment causes the fastener to engage with the receiver to mechanically fasten the removeable cover to the body, wherein moving the lid to close the heating compartment causes the fastener to disengage from the receiver to mechanically unfasten the removeable cover from the body. This arrangement provides a robust fastening and unfastening mechanism.

The removable cover may comprise the receiver. The receiver may be arranged on an inner surface of the removable cover. The fastener may be configured to move with the lid. The fastener may be connected to the lid. The fastener may be connected to the lid by a connecting arm.

Possibly, the fastener comprises a bolt and the receiver comprises a socket, wherein the socket is configured to receive the bolt to engage with the fastener. The bolt may be substantially cylindrical. The bolt may be moveable in a bolt housing. The bolt housing may be arranged on an outer surface of the body.

Possibly, the fastening arrangement provides an electrical switch configured to enable heating in the heating compartment when the lid is moved by a user to open the heating compartment and to disable heating in the heating compartment when the lid is moved by a user to close the heating compartment. Possibly, the electrical switch is configured such that heating is enabled when the fastener is engaged with the receiver and disabled when the fastener is disengaged from the receiver. In such examples, a separate mechanism to detect removal of the removeable cover from the body, for instance based on a hall sensor output signal, and to automatically disable heating for user safety if it is detected that the removeable cover has been removed, is not required. This simplifies the arrangement.

Possibly, the electrical switch is configured such that a conducting path in an electrical circuit is one of connected or disconnected when the fastener is engaged with the receiver to enable heating, and the other of disconnected or connected when the fastener is disengaged from the receiver to disable heating.

### BRIEF DESCRIPTION OF THE DRAWINGS

FIG. 1 is a diagrammatic cross-sectional view of an aerosol generating device, wherein a removeable cover and body of the device are shown side by side;

FIG. 2 is a diagrammatic view of the aerosol generating device of FIG. 1, wherein the removeable cover and body of the device are shown side by side;

FIG. 3 is a diagrammatic view of a fastening arrangement;

FIG. 4a is a diagrammatic view of the aerosol generating device of FIG. 1, wherein the fastening arrangement is in a first condition of use; and

FIG. 4b is a diagrammatic view of the aerosol generating device of FIG. 1, wherein the fastening arrangement is in a second condition of use.

### DETAILED DESCRIPTION OF EMBODIMENTS

Embodiments of the present disclosure will now be described by way of example only and with reference to the accompanying drawings.

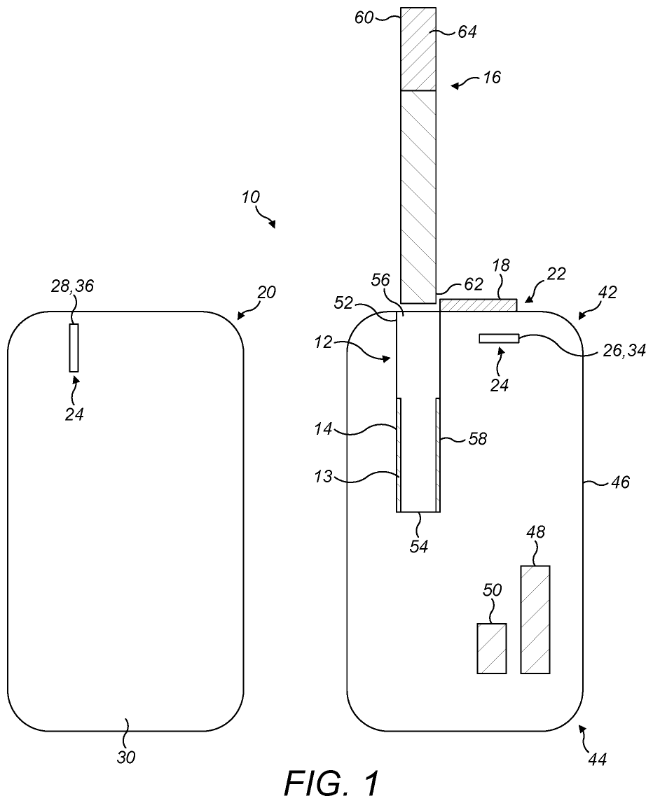

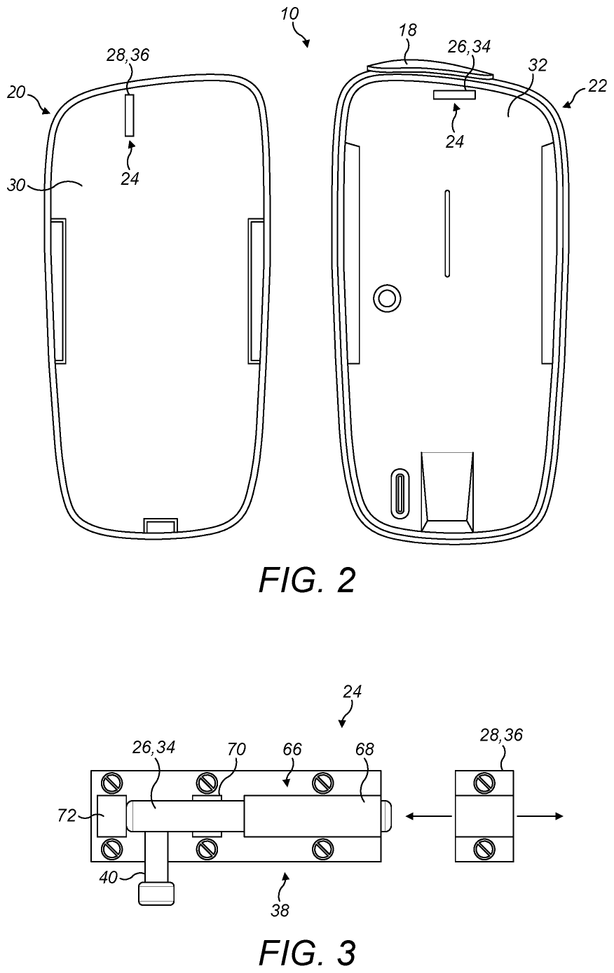

Referring initially to FIGS. 1 and 2, there is shown diagrammatically an aerosol generating device 10 according to the present disclosure. The aerosol generating device 10 comprises a removeable cover 20, i.e., a front cover, and a body 22. The removeable cover 20 is locatable on the body 22. During use of an aerosol generating device 10 in a vaping session, the body 22 can become hot. The removeable cover 20 provides a heat insulation barrier so that the device 10 can be comfortably held by a user during a vaping session. In FIGS. 1 and 2, the removeable cover 20 has been removed from the body 22. The removeable cover 20 and body 22 are shown side by side in a separated condition. The aerosol generating device 10 is configured to be used with an aerosol generating article 16 such that the aerosol generating device 10 and the aerosol generating article 16 together form an aerosol generating system.

The aerosol generating device 10 may equally be referred to as a “heated tobacco device”, a “heat-not-burn tobacco device”, a “device for vaporising tobacco products”, and the like, with this being interpreted as a device suitable for achieving these effects. The features disclosed herein are equally applicable to devices which are designed to vaporise any aerosol generating substrate.

The aerosol generating device 10 is a hand-held, portable, device, by which it is meant that a user is able to hold and support the device unaided, in a single hand. The aerosol generating device 10 has a first (or proximal) end 42 and a second (or distal) end 44 and comprises a device housing 46.

The aerosol generating device 10 includes a controller 48. The aerosol generating device 10 may include a user interface for controlling the operation of the aerosol generating device 10 via the controller 48.

The controller 48 is configured to detect the initiation of use of the aerosol generating device 10, for example, in response to a user input, such as a button press to activate the aerosol generating device 10, or in response to a detected airflow through the aerosol generating device 10. As will be understood by one of ordinary skill in the art, an airflow through the aerosol generating device 10 is indicative of a user inhalation or ‘puff’. The aerosol generating device 10 may, for example, include a puff detector, such as an airflow sensor (not shown), to detect an airflow through the aerosol generating device 10.

The controller 48 includes electronic circuitry. The aerosol generating device 10 includes a power source 50, such as a battery. The power source 50 and the electronic circuitry may be configured to operate at a high frequency in the case of an inductively heated vapour generating device 10. For example, the power source 50 and the electronic circuitry may be configured to 20 operate at a frequency of between approximately 80 kHz and 500 kHz, possibly between approximately 150 kHz and 250 kHz, and possibly at approximately 200 kHz. The power source 50 and the electronic circuitry could be configured to operate at a higher frequency, for example in the MHz range, if required.

25 The aerosol generating device 10 comprises a heating assembly 12. The heating assembly 12 further comprises a heating compartment 14. The heating compartment 14 is arranged to receive an aerosol generating article 16. In some examples, the heating compartment 14 has a substantially cylindrical cross-section. The heating compartment 14 defines a cavity.

30 The heating compartment 14 has a first end 52 and a second end 54. The heating compartment 14 includes an opening 56 at the first end 52 for receiving an aerosol generating article 16. In the illustrated example, the heating compartment 14 includes a substantially cylindrical side wall 58, i.e., a side wall 58 which has a substantially circular cross-section.

The aerosol generating article 16 comprises an aerosol generating substrate. The aerosol generating substrate may be any type of solid or semi-solid material. Example types of aerosol generating solids include powder, granules, pellets, shreds, strands, particles, gel, strips, loose leaves, cut leaves, cut filler, porous material, foam material or sheets. The aerosol generating substrate may comprise plant derived material and in particular, may comprise tobacco. It may advantageously comprise reconstituted tobacco. The aerosol generating substrate may be a tobacco plug.

The aerosol generating substrate may comprise an aerosol-former. Examples of aerosol-formers include polyhydric alcohols and mixtures thereof such as glycerine or propylene glycol. Typically, the aerosol generating substrate may comprise an aerosol-former content of between approximately 5% and approximately 50% on a dry weight basis. In some example, the aerosol generating substrate may comprise an aerosol-former content of between approximately 10% and approximately 20% on a dry weight basis, and possibly approximately 15% on a dry weight basis.

Upon heating, the aerosol generating substrate may release volatile compounds. The volatile compounds may include nicotine or flavour compounds such as tobacco flavouring.

The shape of the aerosol generating article 16 corresponds to the shape of the heating compartment 14. The aerosol generating article 16 may be generally cylindrical or rod-shaped. The aerosol generating article 16 may be formed substantially in the shape of a stick, and may broadly resemble a cigarette, having a tubular region with an aerosol generating substrate arranged in a suitable manner. The aerosol generating article 16 may be a disposable and replaceable article which may, for example, contain tobacco as the aerosol generating substrate. The aerosol generating article 16 may be a heated tobacco stick. The aerosol generating article 16 is a consumable.

The aerosol generating article 16 has a first end 60 (or mouth end), a second end 62, and comprises a filter 64 at the first end 60. The filter 64 acts as a mouthpiece and may comprise an air-permeable plug, for example comprising cellulose acetate fibres.

The aerosol generating substrate and filter 64 may be circumscribed by a paper wrapper and may, thus, be embodied as an aerosol generating article 16. One or more vapour collection regions, cooling regions, and other structure may also be included in some designs.

To use the aerosol generating device 10, a user inserts an aerosol generating article 16 through the opening 56 into the heating compartment 14, so that the second end 62 of the aerosol generating article 16 is positioned at the second end 54 of the heating compartment 14 and so that the filter 64 at the first end 60 of the aerosol generating article 16 projects from the first end 52 of the heating compartment 14 to permit engagement by a user's lips.

The heating assembly 12 comprises a heater 13, i.e., a heating element, arranged to heat the aerosol generating substrate of an aerosol generating article 16 received in the heating compartment 14.

The heating assembly 12 may be an induction heating assembly (not shown). The induction heating assembly further comprises an induction coil (not shown). The induction coil is arranged to be energised to generate an alternating electromagnetic field for inductively heating an induction heatable susceptor (not shown). Accordingly, in such examples the heater 13 is an induction heatable susceptor.

The induction heatable susceptor may be arranged around the periphery of the heating compartment 14. Alternatively, the induction heatable susceptor may be arranged to project into the heating compartment 14 from the second end 54 (e.g., as a heating blade or pin) to penetrate the aerosol generating substrate when the aerosol generating article 16 is inserted into the aerosol generating device 10. In other examples, the induction heatable susceptor is instead provided in the aerosol generating substrate during manufacture of the aerosol generating article 16. In such examples, the aerosol generating article 16 comprises the induction heatable susceptor.

The induction coil can be energised by the power source 50 and controller 48. The induction coil may comprise a Litz wire or a Litz cable. It will, however, be understood that other materials could be used.

The induction coil may extend around the heating compartment 14. Accordingly, the induction coil may be annular. The induction coil may be substantially helical in shape. In some examples, the circular cross-section of a helical induction coil may facilitate the insertion of an aerosol generating article 16 and optionally one or more induction heatable susceptors, into the heating compartment 14 and ensure uniform heating of the aerosol generating substrate.

The induction heatable susceptor comprises an electrically conductive material. The induction heatable susceptor may comprise one or more, but not limited to, of graphite, molybdenum, silicon carbide, niobium, aluminium, iron, nickel, nickel containing compounds, titanium, mild steel, stainless steel, low carbon steel and alloys thereof, e.g., nickel chromium or nickel copper, and composites of metallic materials. In some examples, the induction heatable susceptor comprises a metal selected from the group consisting of mild steel, stainless steel, and low carbon stainless steel.

In use, with the application of an electromagnetic field in its vicinity, the induction heatable susceptor(s) generate heat due to eddy currents and magnetic hysteresis losses resulting in a conversion of energy from electromagnetic to heat.

The induction coil may be arranged to operate in use with a fluctuating electromagnetic field having a magnetic flux density of between approximately 20mT and approximately 2.0T at the point of highest concentration.

An alternative approach is to employ a resistive heating assembly (not shown). In such cases, the heater 13 is a resistive heater (not shown). The resistive heater may surround the aerosol generating substrate and transfer heat to an outer surface of the aerosol generating substrate, for instance, the resistive heater may be arranged around the periphery of the heating compartment 14. Alternatively, the resistive heater may be arranged to project into the heating compartment 14 from the second end 54 (e.g., as a heating blade or pin) to penetrate the aerosol generating substrate when the aerosol generating article 16 is inserted into the aerosol generating device 10. In use, current from the power supply 50 is supplied directly to the resistive heater to generate heat.

In use, heat from the heater 13 (i.e., induction heatable susceptor or resistive heater) is transferred to the aerosol generating substrate of an aerosol generating article 16 positioned in the heating compartment 14, for example by conduction, radiation and convection, to heat the aerosol generating substrate (without burning the aerosol generating substrate) and thereby generate a vapour which cools and condenses to form an aerosol for inhalation by a user of the aerosol generating device 10, for instance, through the filter 64. The vaporisation of the aerosol generating substrate is facilitated by the addition of air from the surrounding environment, e.g., through an air inlet (not shown).

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

As a safety precaution heating is automatically disabled should the removeable cover 20 be removed. In some examples, the controller 48 is configured to detect removal of the removeable cover 20 from the body 22 based on a hall sensor output signal and to automatically disable heating for user safety if it is detected that the removeable cover 20 has been removed.

The aerosol generating device 10 further comprises a lid 18 configured to be moveable by a user to open and close the heating compartment 14. The lid 18 is a closure member. The lid 18 protects the heating compartment 14 when the aerosol generating device 10 is not in use. In the illustrated example, the lid 18 is slidably moveable by a user to open and close the heating compartment 14. In such examples, the lid 18 is a slider.

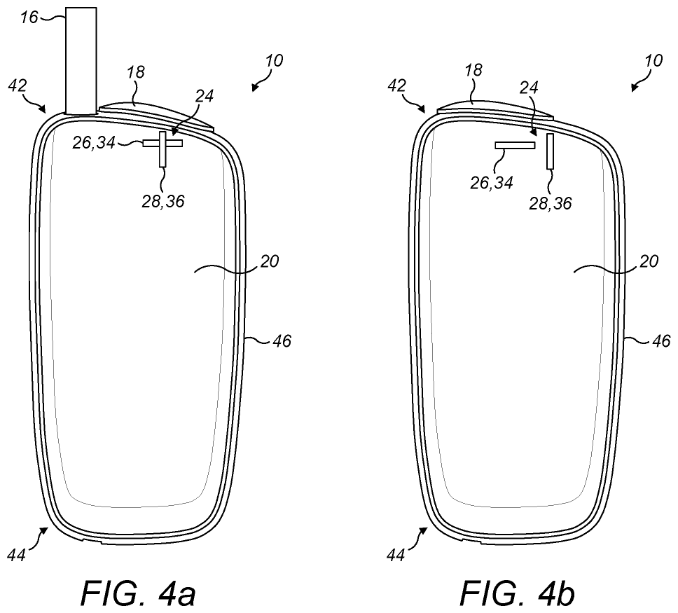

The lid 18 is moveable relative to the opening 56 between a closed position in which the lid 18 covers the opening 56, and an open position in which the opening 56 is unobstructed by the lid 18. In FIGS. 1 and 4a, the lid 18 is in the open position. In the open position, the opening 56 is unobstructed and an aerosol generating article 16 is receivable in the heating compartment 14. In FIGS. 2 and 4b, the lid 18 is in the closed position covering the opening 56.

The aerosol generating device 10 further comprises a fastening arrangement 24. The fastening arrangement 24 is a reversible mechanical fastening arrangement. The fastening arrangement 24 is configured to mechanically fasten the removeable cover 20 to the body 22 when the lid 18 is moved by a user to open the heating compartment 14 and to mechanically unfasten the removeable cover 20 from the body 22 when the lid 18 is moved by a user to close the heating compartment 14. Accordingly, the removeable cover 20 is secured to the body 22 when the lid 18 is in the open position and can be removed from the body 22 when the lid 18 is in the closed position.

In examples wherein the lid 18 is slidably moveable by a user to open and close the heating compartment 14, the sliding motion to close the heating compartment 14 mechanically locks the removable cover 20 in place onto the body 22 of the aerosol generating device 10. The sliding motion to open the heating compartment 14 mechanically unlocks the removable cover 20 from the body 22 so that the removable cover 20 can be removed.

An aerosol generating article 16 can only be received in the heating compartment 14 of an aerosol generating device 10 when the heating compartment 14 is open. The aerosol generating device 10 can only therefore be used for a vaping session when the heating compartment 14 is open (and an aerosol generating article 16 is received therein). Thus, the opening 56 of the heating compartment 14 must be unobstructed by the lid 18 for the aerosol generating device 10 to be used for a vaping session. In this configuration, the removeable cover 20 is mechanically fastened to the body 22 by the fastening arrangement 24. The fastening arrangement 24 can only be unfastened to permit removal of the removeable cover 20 by a user moving the lid 18 to close the heating compartment 14 after the aerosol generating article 16 has been removed, for instance at the end of a vaping session. This arrangement therefore prevents inadvertent removal of the removeable cover 20 during a vaping session and automatic disabling of heating, and thus the associated inconvenience caused by disrupting the vaping session. This arrangement also mitigates safety risks associated with exposing a potentially hot body 22. Accordingly, during a vaping session, the removeable cover 20, i.e., front cover, cannot be removed without the use of excess force.

The fastening arrangement 24 comprises a fastener 26 and a receiver 28. In the illustrated example, the removable cover 20 comprises the receiver 28. The receiver 28 is arranged on an inner surface 30 of the removable cover 20. The receiver 28 is provided on the inner surface 30 of the removable cover 20. The receiver 28 may be connected to the inner surface 30 of the removable cover 20.

In the illustrated example, the fastener 26 is configured to move with the lid 18. The fastener 26 is therefore associated with the lid 18. The fastener 26 is provided on an outer surface 32 of the body 22.

In use, moving the lid 18 to open the heating compartment 14 causes the fastener 26 to engage with the receiver 28 to mechanically fasten the removeable cover 20 to the body 22. Moving the lid 18 to close the heating compartment 14 causes the fastener 26 to disengage from the receiver 28 to mechanically unfasten the removeable cover 20 from the body 22. This arrangement provides a robust fastening and unfastening mechanism.

Referring to FIG. 3, a detailed view of the fastening arrangement 24 is shown diagrammatically. In the illustrated example, the fastener 26 comprises a substantially cylindrical bolt 34, i.e., a barrel, and the receiver 28 comprises a socket 36, i.e., a keep, catch or latch. The socket 36 is arranged on the inner surface 30 of the removable cover 20. The socket 36 is connected to the inner surface 30 of the removable cover 20. The socket 36 is configured to receive the bolt 34 to engage with the fastener 26. In the illustrated example, when the removeable cover 20 is located on the body 22 a user moving the lid 18 to open the heating compartment 14 causes the bolt 34 to slide into the socket 36.

The bolt 34 is moveable in a bolt housing 38, i.e., a barrel plate, arranged on an outer surface 32 of the body 22. The bolt housing 38 is connected to the outer surface 32 of the body 22. Accordingly, the bolt 34 is exposed on the outside of the body 22 and is concealed by the removeable cover 20 when the removeable cover 20 is located on the body 22. In the illustrated example, the bolt housing 38 comprises a guiding mechanism 66 comprising a tail keep 68, slit or middle keep 70 and a head keep 72.

The fastener 26 is connected to the lid 18 by a connecting arm 40. Accordingly, in use, moving the lid 18 causes the fastener 26 to move correspondingly by virtue of the connecting arm 40. The lid 18 therefore provides a carriage for the fastener 26.

Referring to FIGS. 4a and 4b, the fastening arrangement 24 is shown diagrammatically superimposed over the removeable cover 20 in order to illustrate the relationship between the fastener 26 and receiver 28. In FIG. 4a, the lid 18 is in the open position and the fastener 26 is engaged with the receiver 28. The opening 56 is therefore unobstructed by the lid 18. The fastening arrangement 24 is in a first condition of use. The removeable cover 20 is therefore mechanically fastened to the body 22 and the heating compartment 14 is open. In the illustrated example, an aerosol generating article 16 is received in the heating compartment 14. In FIG. 4b, the lid 18 is in the closed position and the fastener 26 is disengaged from the receiver 28.

The heating compartment 14 is therefore closed by the lid 18. The fastening arrangement 24 is in a second condition of use. The removeable cover 20 is therefore mechanically unfastened from the body 22 and thus the removeable cover 20 can be removed from the body 22.

In some examples, the fastening arrangement 24 provides an electrical switch. The electrical switch is configured to enable heating in the heating compartment 14 when the lid 18 is moved by a user to open the heating compartment 14. The electrical switch is configured to disable heating in the heating compartment 14 when the lid 18 is moved by a user to close the heating compartment 14.

The electrical switch is configured such that heating is enabled when the fastener 26 is engaged with the receiver 28 and disabled when the fastener 26 is disengaged from the receiver 28. A conducting path in an electrical circuit is one of connected or disconnected when the fastener 26 is engaged with the receiver 28 to enable heating. When the fastener 26 is disengaged from the receiver 28, the electrical circuit is the other of disconnected or connected to disable heating.

In the illustrated example, heating in the heating compartment 14 is enabled when the conducting path in the electrical circuit is connected (i.e., the electrical switch is closed) by virtue of the fastener 26 engaging with the receiver 28 and disabled when the conducting path in the electrical circuit is disconnected (i.e., the electrical switch is open) by virtue of the fastener 26 and receiver 28 being in a disengaged condition.

In use, moving the lid 18 to open the heating compartment 14 enables heating caused by the fastener 26 engaging with the receiver 28. An aerosol generating article 16 can then be received in the heating compartment 14 and the heater 13 can be activated to initiate a vaping session, for example, in response to a user input or in response to a detected airflow through the aerosol generating device. Moving the lid 18 to close the heating compartment 14 disables heating caused by the fastener 26 disengaging from the receiver 28. The heater 13 cannot therefore be activated to initiate a vaping session. In such examples, a separate mechanism to detect removal of the removeable cover 20 from the body 22, for instance based on a hall sensor output signal, and to automatically disable heating for user safety if it is detected that the removeable cover 20 has been removed, is not required. This simplifies the arrangement.

The Figures also illustrate a method of manufacturing an aerosol generating device 10 according to examples of the disclosure. The Figures also illustrate a method of providing an aerosol generating system according to examples of the disclosure.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An aerosol generating device comprising:
a heating assembly, comprising a heating compartment arranged to receive an aerosol generating article;
a lid configured to be moveable by a user to open and close the heating compartment;
a removeable cover locatable on a body of the aerosol generating device; and
a fastening arrangement configured to mechanically fasten the removeable cover to the body when the lid is moved by a user to open the heating compartment and to mechanically unfasten the removeable cover from the body when the lid is moved by a user to close the heating compartment.

2. The aerosol generating device according claim 1, wherein the lid is linearly slidable by a user to open and close the heating compartment.

3. The aerosol generating device according to claim 1- or 2, wherein the fastening arrangement comprises:
a fastener; and
a receiver, wherein, in use, moving the lid to open the heating compartment is configured to cause the fastener to engage with the receiver to mechanically fasten the removeable cover to the body, and wherein moving the lid to close the heating compartment is configured to cause the fastener to disengage from the receiver to mechanically unfasten the removeable cover from the body.

4. The aerosol generating device according to claim 3, wherein the removable cover comprises the receiver.

5. The aerosol generating device according to claim 4, wherein the receiver is arranged on an inner surface of the removable cover.

6. The aerosol generating device according to claim 3, wherein the fastener is configured to move with the lid.

7. The aerosol generating device according to claim 6, wherein the fastener is connected to the lid.

8. The aerosol generating device according to claim 7, wherein the fastener is connected to the lid by a connecting arm.

9. The aerosol generating device according to claim 3, wherein the fastener comprises a bolt and the receiver comprises a socket, wherein the socket is configured to receive the bolt to engage with the fastener.

10. The aerosol generating device according to claim 9, wherein the bolt is substantially cylindrical.

11. The aerosol generating device according to claim 9- or 10, wherein the bolt is moveable in a bolt housing.

12. The aerosol generating device according to claim 11, wherein the bolt housing is arranged on an outer surface of the body.

13. The aerosol generating device according to claim 1,
wherein the fastening arrangement comprises an electrical switch configured to enable heating in the heating compartment when the lid is moved by a user to open the heating compartment and to disable heating in the heating compartment when the lid is moved by a user to close the heating compartment.

14. The aerosol generating device according to claim 13, wherein the fastening arrangement comprises:
a fastener; and
a receiver, wherein, in use, moving the lid to open the heating compartment is configured to cause the fastener to engage with the receiver to mechanically fasten the removeable cover to the body, and wherein moving the lid to close the heating compartment is configured to cause the fastener to disengage from the receiver to mechanically unfasten the removeable cover from the body, and
wherein the electrical switch is configured such that heating is enabled when the fastener is engaged with the receiver and disabled when the fastener is disengaged from the receiver.

15. The aerosol generating device according to claim 13, wherein the fastening arrangement comprises:
a fastener; and
a receiver, wherein, in use, moving the lid to open the heating compartment is configured to cause the fastener to engage with the receiver to mechanically fasten the removeable cover to the body, and wherein moving the lid to close the heating compartment is configured to cause the fastener to disengage from the receiver to mechanically unfasten the removeable cover from the body, and
wherein the electrical switch is configured such that a conducting path in an electrical circuit is one of connected or disconnected when the fastener is engaged with the receiver to enable heating, and other of disconnected or connected when the fastener is disengaged from the receiver to disable heating.
